(19) United States
(12) Patent Application Publication
(10) Pub. No.: US 2014/0043877 A1
(43) Pub. Date: Feb. 13, 2014

(54) POWER FACTOR CORRECTION CONVERTER

(71) Applicant: PANASONIC CORPORATION, Osaka (JP)

(72) Inventor: Takuya ISHII, Osaka (JP)

(73) Assignee: PANASONIC CORPORATION, Osaka (JP)

(21) Appl. No.: 14/057,845

(22) Filed: Oct. 18, 2013

Related U.S. Application Data
(63) Continuation of application No. PCT/JP2012/001212, filed on Feb. 22, 2012.

(30) Foreign Application Priority Data
Apr. 27, 2011 (JP) 2011-099399

(51) Int. Cl. H02M 1/42

(52) U.S. Cl. CPC H02M 1/4208
USPC 363/84

(57) ABSTRACT

A power factor correction converter includes: a light load detection circuit configured to generate, if supplied power to a load is less than or equal to a predetermined value, a light load detection signal whose level corresponds to the supplied power; a target waveform generation circuit configured to generate, based on an input DC voltage, a target waveform of an inductor current flowing through an inductor; and a drive signal generation circuit configured to generate a drive signal driving a switch such that the inductor current follows the target waveform. The target waveform generation circuit is configured to generate, if the light load detection signal indicates a light load, the target waveform that includes a zero level period in which an amplitude of the target waveform is zero level, the zero level period being adjusted in accordance with the level of the light load detection signal.

This is a continuation application under 35 U.S.C 111(a) of pending prior International Application No. PCT/JP2012/001212, filed on Feb. 22, 2012.

### BACKGROUND OF THE INVENTION

1. Field of the Invention

The present invention relates to a power factor correction converter configured to perform a PFC (Power Factor Correction) operation of supplying a DC voltage to a load while correcting the power factor of a voltage inputted from an AC power supply. The present invention particularly relates to a power factor correction converter to which a technique for output stabilization in a light load state is applied.

2. Description of the Related Art

There is a known power factor correction converter configured to perform a PFC operation of supplying a DC voltage to a load based on a rectified voltage that is inputted via a full-wave rectifier circuit from an AC power supply. Generally speaking, such a power factor correction converter includes an inductor to which the rectified voltage inputted via the full-wave rectifier circuit is applied, and controls an inductor current flowing through the inductor to follow a sine waveform whose amplitude has been adjusted for stabilizing an output voltage. Usually, such a sine waveform for controlling the inductor current is generated based on the rectified voltage inputted via the full-wave rectifier circuit. The output voltage obtained by controlling the inductor current is set by adjusting, through switching, how much energy stored in the inductor is used to charge a constant power supply unit such as a capacitor. Here, in a case where there is almost no load connected to the output of the power factor correction converter or a load connected to the output of the power factor correction converter is light, it is necessary to control the inductor current within a significantly small range (close to zero) in order to reduce an output current to the load. However, in such a range where the inductor current is significantly small, a target amplitude of the sine waveform is significantly small. For this reason, influence of, for example, a circuit delay and an offset voltage becomes relatively great, which causes an error in a switching command. If such an error occurs in the switching command, there arises a problem in that the output voltage becomes unstable, for example, the output voltage increases in an unintended manner.

There are techniques intended to reduce such instability in the output voltage when the load is light. For example, there is a proposed technique in which a light load state is detected, and in the light load state, the voltage division ratio of a voltage detection resistor provided for detecting the inductor current is changed to increase the detection sensitivity so that even a small inductor current can be controlled (e.g., Japanese Laid-Open Patent Application Publication No. 2000-262059).

As another example, there is a proposed technique in which, in a light load state, the response speed of a feedback circuit for stabilizing the output voltage is increased, and thereby control is switched to perform control that prioritizes output stabilization over input power factor correction (see Japanese Laid-Open Patent Application Publication No. 2000-324810).

### SUMMARY OF THE INVENTION

However, even if the detection sensitivity is increased for controlling the inductor current as disclosed in Japanese Laid-Open Patent Application Publication No. 2000-262059, the influence of a delay and an offset voltage in a circuit for generating a target sine waveform cannot be eliminated. Moreover, in a case where the response speed of a feedback circuit is increased as disclosed in Japanese Laid-Open Patent Application Publication No. 2000-324810, the ON period (voltage applied period) of a switch becomes significantly short. As a result, problems arise in that a proper ON period cannot be generated and intermittent operation occurs regardless of an intended waveform to be generated. In addition, in both of the above techniques, the gain of a feedback path varies. Therefore, there is also a problem of instability in output voltage, which is caused by such a variation in the gain.

The present invention solves the above conventional problems. An object of the present invention is to provide a power factor correction converter capable of readily adjusting the inductor current even in a light load state and preventing an occurrence of intermittent operation until the load state becomes a lighter load state.

A power factor correction converter according to the present invention includes: a rectifier configured to rectify an AC voltage inputted from an AC power supply into an input DC voltage; an inductor, one end of which is connected to a positive output terminal of the rectifier and to which the input DC voltage is applied; a power storage circuit element connected to another end of the inductor via a rectifier circuit element and configured to generate, by storing electric power, an output DC voltage to be outputted to a load; a switch, one main terminal of which is connected to the other end of the inductor and another main terminal of which is connected to a negative output terminal of the rectifier, the switch being configured to perform switching operations of connecting between the inductor and the negative output terminal to store energy in the inductor and disconnecting between the inductor and the negative output terminal to charge the power storage circuit element; a light load detection circuit configured to generate, if supplied power to the load is less than or equal to a predetermined value, a light load detection signal whose level corresponds to the supplied power; a target waveform generation circuit configured to generate, based on the input DC voltage, a target waveform of an inductor current flowing through the inductor; and a drive signal generation circuit configured to generate a drive signal driving the switch such that the inductor current follows the target waveform. The target waveform generation circuit is configured to generate, if the light load detection signal indicates a light load, the target waveform that includes a period in which an amplitude of the target waveform is zero level (hereinafter, a zero level period), the zero level period being adjusted in accordance with the level of the light load detection signal.

According to the above configuration, if the light load detection signal indicates a light load, a target waveform is generated, the target waveform including a zero level period in which the amplitude of the target waveform is zero level, the zero level period corresponding to the degree of the light load (i.e., corresponding to the level of the light load detection signal). Accordingly, even in a light load state, the total amount of current can be reduced while suppressing a decrease in the wave height of the inductor current. This makes it possible to readily adjust the inductor current even in a light load state and prevent an occurrence of intermittent operation until the load state becomes a lighter load state.

The target waveform generation circuit may be configured to generate, based on the output DC voltage, the target waveform that causes the output DC voltage to have a predetermined voltage value. According to this configuration, the output DC voltage applied to the load is controlled to have a predetermined voltage value. Accordingly, even in a light load state, the output DC voltage applied to the load can be stabilized to be a desired voltage value.

The light load detection circuit may be configured such that, if a voltage based on the supplied power has become lower than or equal to a predetermined reference voltage, the light load detection circuit outputs, as the light load detection signal, a voltage proportional to a first differential voltage obtained by subtracting the voltage based on the supplied power from the reference voltage. The target waveform generation circuit may be configured such that, if a voltage based on the input DC voltage is lower than or equal to a voltage value of the light load detection signal, the target waveform generation circuit generates the target waveform such that the amplitude of the target waveform becomes zero level. According to this configuration, a light load state is detected if the voltage based on the supplied power has become lower than or equal to the predetermined reference voltage. In a case where a light load state has been detected, the amplitude of the generated target waveform is zero level in a period in which the voltage based on the input DC voltage is lower than or equal to the voltage proportional to the first differential voltage obtained by subtracting the voltage based on the supplied power from the reference voltage. Thus, with a simple configuration, a light load state can be detected and a zero level period can be set in accordance with the degree of the light load.

The light load detection circuit may be configured to detect the output DC voltage as the supplied power. Alternatively, the light load detection circuit may be configured to detect, as the supplied power, an output current flowing through the load.

The light load detection circuit may be configured to: compare a voltage based on the output DC voltage that is inputted to the target waveform generation circuit with a predetermined reference voltage; and if the voltage based on the output DC voltage has become lower than or equal to the reference voltage, output, as the light load detection signal, a voltage proportional to differential power obtained by subtracting the voltage based on the output DC voltage from the reference voltage. The target waveform generation circuit may include: a calculator configured such that, if a voltage based on the input DC voltage is lower than or equal to a voltage value of the light load detection signal, the calculator outputs zero level, and if the voltage based on the input DC voltage is higher than the voltage value of the light load detection signal, the calculator outputs a second differential voltage obtained by subtracting the voltage value of the light load detection signal from the voltage based on the input DC voltage; and a multiplier configured to generate the target waveform by multiplying a voltage outputted from the calculator by the voltage based on the output DC voltage. According to this configuration, in a case where a light load state has been detected, such a voltage waveform as to cause the amplitude of the generated target waveform to become zero level is generated in a period in which the voltage based on the input DC voltage is lower than or equal to the voltage proportional to the first differential voltage obtained by subtracting the voltage based on the supplied power from the reference voltage. Thus, with a simple configuration, a light load state can be detected; a zero level period can be set in accordance with the degree of the light load; and the output DC voltage can be stabilized to be a desired voltage value.

The light load detection circuit may be configured to: compare a voltage based on the output DC voltage that is inputted to the target waveform generation circuit with a predetermined reference voltage; and if the voltage based on the output DC voltage has become lower than or equal to the reference voltage, output, as the light load detection signal, a voltage proportional to differential power obtained by subtracting the voltage based on the output DC voltage from the reference voltage. The target waveform generation circuit may include: a multiplier configured to generate a multiplied voltage by multiplying together a voltage based on the input DC voltage and the voltage based on the output DC voltage; and a calculator configured such that, if the multiplied voltage is lower than or equal to a voltage value of the light load detection signal, the calculator outputs zero level, and if the multiplied voltage is higher than the voltage value of the light load detection signal, the calculator generates the target waveform by subtracting the voltage value of the light load detection signal from the multiplied voltage. According to this configuration, in a case where the load state is determined to be a light load state when the voltage based on the input DC voltage and the voltage based on the output DC voltage have previously been multiplied together, such a voltage waveform as to cause the amplitude of the generated target waveform to become zero level is generated in a period in which the multiplied voltage is lower than or equal to the voltage proportional to the first differential voltage obtained by subtracting the voltage based on the supplied power from the reference voltage. Thus, with a simple configuration, determination can be made as to whether the load state is a light load state or not; a zero level period can be set in accordance with the degree of the light load; and the output DC voltage can be stabilized to be a desired voltage value.

The above and further objects, features, and advantages of the present invention will more fully be apparent from the following detailed description with accompanying drawings.

The present invention is configured as described above, and provides advantages of being able to readily adjust the inductor current even in a light load state and prevent an occurrence of intermittent operation until the load state becomes a lighter load state.

### BRIEF DESCRIPTION OF THE DRAWINGS

FIG. 1 is a circuit diagram showing an example of a schematic configuration of a switching power supply device to which a power factor correction converter according to Embodiment 1 of the present invention is applied.

FIG. 2 is a graph showing an example of voltage and current waveforms in components of the switching power supply device shown in FIG. 1.

FIG. 3 is a graph showing a comparison of an inductor current of the switching power supply device shown in FIG. 1 with a comparative example.

FIG. 4 is a circuit diagram showing an example of a more detailed configuration of the switching power supply device shown in FIG. 1.

FIG. 5 is a circuit diagram showing an example of a schematic configuration of a switching power supply device to which a power factor correction converter according to Embodiment 2 of the present invention is applied.

FIG. 6 is a circuit diagram showing an example of a schematic configuration of a switching power supply device to which a power factor correction converter according to Embodiment 3 of the present invention is applied.

### DESCRIPTION OF THE PREFERRED EMBODIMENTS

Hereinafter, embodiments of the present invention are described with reference to the drawings. In the drawings, the same or corresponding components are denoted by the same reference signs, and a repetition of the same description is avoided.

### Embodiment 1

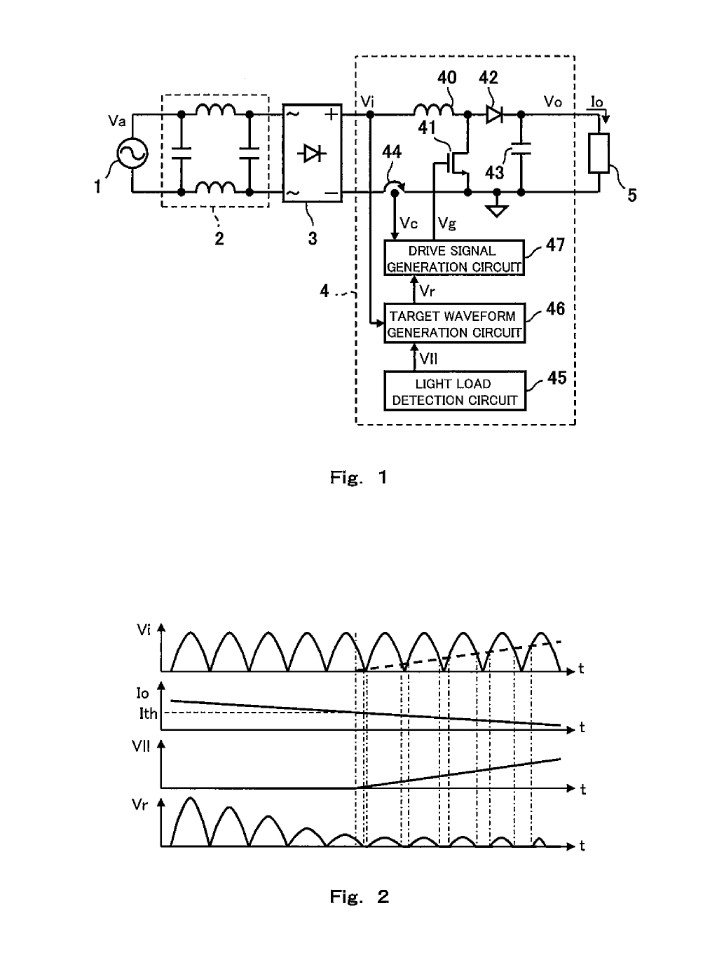

First, a power factor correction converter according to Embodiment 1 of the present invention is described. FIG. 1 is a circuit diagram showing an example of a schematic configuration of a switching power supply device to which the power factor correction converter according to Embodiment 1 of the present invention is applied.

As shown in FIG. 1, an AC power supply 1 configured to supply an AC voltage Va, which is a power supply voltage, is provided as a power supply for the switching power supply device. An input filter 2 is connected to an output terminal of the AC power supply 1 and configured to filter an output from the AC power supply 1. The input filter 2 is a known low-pass filter including inductors and capacitors. A rectifier (in the present embodiment, a full-wave rectifier circuit) 3 configured to rectify the AC voltage that is outputted from the input filter 2 into an input DC voltage Vi is connected to an output terminal of the input filter 2. The full-wave rectifier circuit 3 performs full-wave rectification of the AC voltage Va, and outputs a resultant rectified voltage which is the input DC voltage Vi. A boost converter 4 serving as a power factor correction converter is provided between the full-wave rectifier circuit 3 and a load 5. The boost converter 4 boosts the input DC voltage Vi to generate an output DC voltage Vo, and supplies the output DC voltage VO to the load 5.

The boost converter 4 includes: an inductor 40, one end of which is connected to a positive output terminal of the full-wave rectifier circuit 3 and to which the input DC voltage Vi is applied; a power storage circuit element 43 connected to the other end of the inductor 40 via a rectifier circuit element 42 and configured to generate, by storing electric power, the output DC voltage Vo to be outputted to the load; and a switch 41 whose main terminals are connected between the other end of the inductor 40 and a negative output terminal of the full-wave rectifier circuit 3. In the present embodiment, a diode is used as the rectifier circuit element 42, and an output capacitor is used as the power storage circuit element 43. The anode side of the diode 42 is connected to the other end of the inductor 40, and the diode 42 rectifies a current outputted from the inductor 40. The output capacitor 43 is connected to the cathode terminal of the diode 42, and an electric charge is accumulated in the output capacitor 43 by the current rectified by the diode 42. As a result of the output capacitor 43 storing electric power in such a manner, a voltage is applied to the load 5, that is, the output DC voltage Vo is supplied to the load 5. One main terminal of the switch 41 is connected to the other end of the inductor 40, and the other main terminal of the switch 41 is connected to the negative output terminal of the full-wave rectifier circuit 3. The negative output terminal of the full-wave rectifier circuit 3 is connected to a predetermined constant power supply unit (e.g., the ground).

In the switching power supply device according to the present embodiment, the switch 41 connects between the inductor 40 and the negative output terminal (i.e., ON state) to store energy in the inductor 40, and disconnects between the inductor 40 and the negative output terminal (i.e., OFF state) to charge the output capacitor 43 with the energy stored in the inductor 40.

Although in the present embodiment a diode is used as the rectifier circuit element 42, a different rectifier circuit element such as a synchronous rectifier or a switching circuit may be applied alternatively. Although in the present embodiment an output capacitor is used as the power storage circuit element 43, the power storage circuit element 43 is not limited to an output capacitor, but may be, for example, a secondary battery, so long as the power storage circuit element 43 is a circuit element configured to be charged with the energy stored in the inductor 40. Although in the present embodiment the switch 41 is configured as an N-channel MOSFET, the switch 41 is not limited to an N-channel MOSFET, but may be, for example, a P-channel MOSFET or a different transistor capable of performing switching operations such as a bipolar transistor. Although in the present embodiment the constant power supply unit connected to the other main terminal of the switch 41 outputs a ground potential, the constant power supply unit may have a different predetermined potential. Although in the present embodiment a boost converter serves as one example of the power factor correction converter 4, the power factor correction converter 4 may alternatively be a buck converter or a buck-boost converter, for example.

In the present embodiment, the boost converter 4 includes: a target waveform generation circuit 46 configured to generate, based on the input DC voltage Vi, a target waveform of an inductor current flowing through the inductor 40 (in the present embodiment, a target waveform voltage Vr); and a drive signal generation circuit 47 configured to generate a drive signal (drive voltage) Vg, which drives the switch 41 such that the inductor current follows the target waveform (target waveform voltage Vr). The drive signal generation circuit 47 is configured to perform such PWM control as to vary the switching frequency of the inductor current in accordance with the proportion of a connected time Ton to a switching cycle T of the switch 41 (switching cycle T=connected time Ton+disconnected time Toff), i.e., in accordance with a duty ratio δ (duty ratio δ=Ton/T).

Accordingly, the boost converter 4 includes a current detection circuit 44 configured to detect the inductor current. In the present embodiment, the current detection circuit 44 detects a voltage Vc based on the inductor current. The drive signal generation circuit 47 compares the target waveform voltage Vr generated by the target waveform generation circuit 46 with the voltage Vc based on the inductor current, and compares a difference between the voltages, i.e., an error voltage, with a ramp voltage having a predetermined switching frequency, thereby generating the drive signal Vg, which is a pulse signal controlling the switching operation of the switch 41.

The boost converter 4 includes a light load detection circuit 45 configured to generate, if supplied power to the load 5 is less than or equal to a predetermined value, a light load detection signal Vll whose level (magnitude) corresponds to the supplied power. The target waveform generation circuit 46 is configured to generate, if the light load detection signal Vll indicates a light load, the target waveform (target waveform voltage Vr) that includes a period in which the amplitude of the target waveform is zero level (hereinafter, referred to as a zero level period), the zero level period being adjusted in accordance with the level of the light load detection signal Vll.

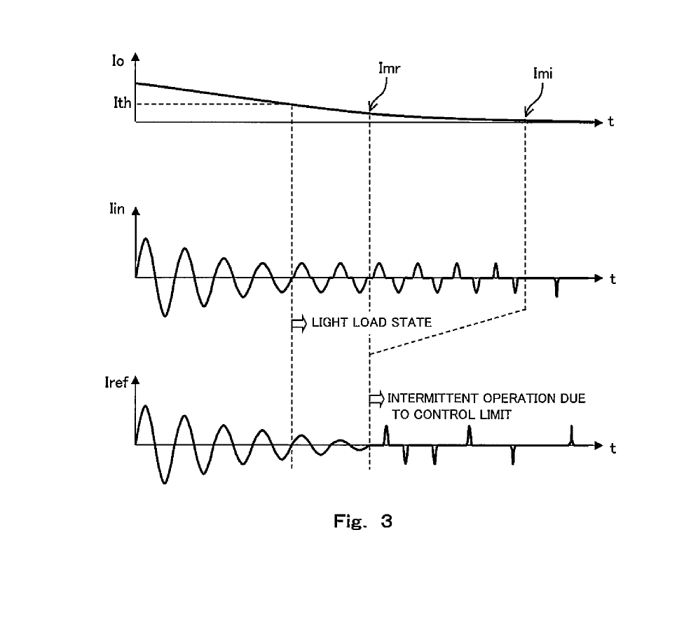

FIG. 2 is a graph showing an example of voltage and current waveforms in components of the switching power supply device shown in FIG. 1. As shown in FIG. 2, the input DC voltage Vi outputted from the full-wave rectifier circuit 3 has a full-wave rectification waveform with a predetermined cycle. If the load 5 becomes lighter, then the supplied power to the load 5 decreases, and an output current Io flowing through the load 5 decreases. If the output current Io has become less than or equal to a predetermined threshold current Ith, the light load detection circuit 45 outputs the light load detection signal Vll. If the output current Io is greater than the threshold current Ith, the light load detection circuit 45 outputs zero level. The light load detection circuit 45 is configured such that, if the output current Io has become less than or equal to the threshold current Ith, the light load detection circuit 45 outputs the light load detection signal Vll whose voltage value is such that the less the output current Io, the higher the voltage value.

Further, in the present embodiment, if a voltage based on the input DC voltage Vi is lower than or equal to the voltage value of the light load detection signal Vll, the target waveform generation circuit 46 outputs zero level, and if the voltage based on the input DC voltage Vi is higher than the voltage value of the light load detection signal Vll, the target waveform generation circuit 46 generates, as the target waveform voltage Vr, a voltage that is obtained by subtracting the voltage value of the light load detection signal Vll from the voltage based on the input DC voltage Vi. For example, the target waveform generation circuit 46 generates the target waveform voltage Vr such that the value of the target waveform voltage Vr is a positive value of a voltage kVi-Vll obtained by subtracting the voltage value of the light load detection signal Vll from a voltage kVi (k is a constant) proportional to the input DC voltage Vi (i.e., if kVi>Vll, then Vr=kVi−Vll, and if kVi≦Vll, then Vr=0). The drive signal generation circuit 47 generates the drive signal Vg which causes the switch 41 to perform switching such that the shape of the waveform of the inductor current becomes similar to the shape of the target waveform generated in the above manner. It should be noted that, in FIG. 2, for the sake of simplifying the drawing, a target waveform obtained by directly subtracting the voltage value of the light load detection signal Vll from the input DC voltage Vi (i.e., the case of k=1) is shown.

According to the above configuration, if a light load state has been detected by the light load detection signal Vll from the light load detection circuit 45, the target waveform generation circuit 46 generates a target waveform including a zero level period in which the amplitude of the target waveform is zero level, the zero level period corresponding to the degree of the light load, the degree being indicated by the light load detection signal Vll. As a result, even in a light load state, the total amount of current can be reduced while suppressing a decrease in the wave height of the inductor current. This makes is possible to stabilize the output to the load 5 at a lower inductor current. It should be noted that, in reality, the input DC voltage Vi outputted from the full-wave rectifier circuit 3 has periodicity. Therefore, the output current Io contains ripples due to the periodicity of the input DC voltage Vi. That is, “stabilization” described herein means stabilizing DC components, and the output current Io supplied to the load 5 is allowed to contain such ripples due to the periodicity of the input DC voltage Vi.

FIG. 3 illustrates advantageous effects of the present embodiment. FIG. 3 is a graph showing a comparison of the inductor current of the switching power supply device shown in FIG. 1 with a comparative example. FIG. 3 shows, along with the output current Io, an inductor current waveform Iin in a case where target waveform adjustment in a light load state according to the present embodiment has been performed. FIG. 3 also shows, as a comparative example along with the output current Io, an inductor current waveform Iref in a case where the target waveform adjustment in a light load state has not been performed. As shown in FIG. 3, in the comparative example where the target waveform adjustment in a light load state is not performed, unstable intermittent operation occurs in a wave height range where the wave height is reduced to a certain degree or more, regardless of the value of the output current Io.

Meanwhile, in the present embodiment, in a case where the light load detection signal Vll indicates a light load, the less the output current Io, the longer the zero level period of the generated waveform. In this case, the wave height (maximum amplitude) of the inductor current in the light load state does not vary much. Thus, according to the boost converter 4 of the present embodiment, in a light load state, a zero level period is set to suppress a decrease in the wave height of the inductor current, and thereby a control limit value Imi of the output current Io can be made to be less than a control limit value Imr in the comparative example. Thus, according to the boost converter 4 of the present embodiment, the output to the load can be stabilized even in a range equal to or lower than the value Imr of the output current Io, at which value the control limit is reached in the comparative example. As described above, according to the present embodiment, the inductor current can be readily adjusted even in a light load state, and intermittent operation can be prevented from occurring until the load state becomes a lighter load state.

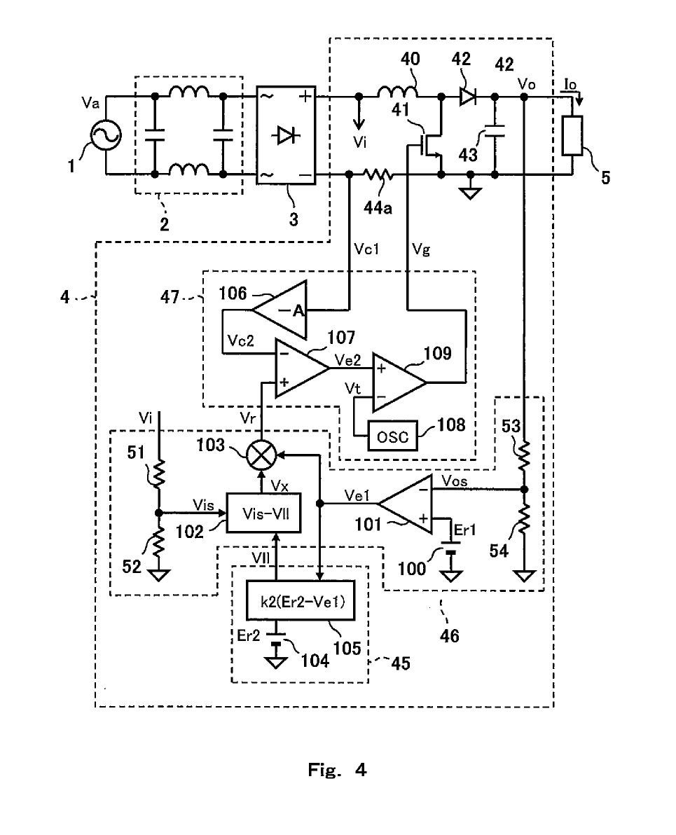

Hereinafter, the configuration according to the present embodiment is described in more detail. FIG. 4 is a circuit diagram showing an example of a more detailed configuration of the switching power supply device shown in FIG. 1. As shown in FIG. 4, the target waveform generation circuit 46 includes: resistors 51 and 52 configured to divide the input DC voltage Vi to generate an input detection voltage Vis (voltage based on the input DC voltage Vi); and a calculator 102 to which the light load detection signal Vll outputted from the light load detection circuit 45 and the input detection voltage Vis are inputted, the calculator 102 being configured to calculate, based on the light load detection signal Vll and the input detection voltage Vis, a target waveform reference voltage Vx which serves as a reference for the target waveform.

Further, the target waveform generation circuit 46 is configured to generate, based on the output DC voltage Vo, the target waveform voltage Vr that causes the output DC voltage Vo to have a predetermined voltage value. Specifically, the target waveform generation circuit 46 includes: resistors 53 and 54 configured to divide the output DC voltage Vo to generate an output detection voltage Vos; an error amplifier 101 configured to amplify an error between the output detection voltage Vos and a predetermined first reference voltage Er1 to output a first error voltage Ve1; a first reference supply 100 configured to generate the first reference voltage Er1; and a multiplier 103 configured to generate a target waveform (target waveform voltage Vr) by multiplying the target waveform reference voltage Vx outputted from the calculator 102 by the first error voltage Ve1 which is based on the output DC voltage Vo. The calculator 102 may be configured as a circuit or a computer such as a microcontroller.

The light load detection circuit 45 according to the present embodiment is configured to detect the output DC voltage Vo as the supplied power to the load 5. Accordingly, the light load detection circuit 45 according to the present embodiment uses, as a voltage based on the supplied power, the first error voltage Ve1 which is generated by the target waveform generation circuit 46 based on the output DC voltage Vo. Moreover, the light load detection circuit 45 is configured such that, if the voltage Ve1 based the supplied power (the first error voltage) has become lower than or equal to a predetermined reference voltage (second reference voltage) Er2, the light load detection circuit 45 outputs, as the light load detection signal Vll, a voltage k2 (Er2−Ve1) (k2 is a constant) proportional to a first differential voltage (Er2−Ve1) obtained by subtracting the first error voltage Ve1 from the second reference voltage Er2. Accordingly, the light load detection circuit 45 includes: a calculator 105 configured to calculate the light load detection signal Vll based on the first error voltage Ve1 and the second reference voltage Er2; and a second reference supply 104 configured to generate the second reference voltage Er2. Similar to the calculator 102, the calculator 105 may be configured as a circuit or a computer such as a microcontroller.

The calculator 102 of the target waveform generation circuit 46 is configured such that, if the input detection voltage Vis (voltage based on the input DC voltage Vi) is lower than or equal to the voltage value of the light load detection signal Vll, the calculator 102 generates the target waveform voltage Vr such that the amplitude of the target waveform voltage Vr is zero level. Further, the calculator 102 is configured such that, if the input detection voltage Vis is higher than the voltage value of the light load detection signal Vll, the calculator 102 outputs a differential voltage (Vis−Vll) obtained by subtracting the light load detection signal Vll from the input detection voltage Vis.

As previously described, when the load 5 becomes lighter, the output current Io flowing through the load 5 decreases, causing an increase in the output DC voltage Vo. As a result, the output detection voltage Vos, which is obtained as a result of the output DC voltage Vo being divided by the resistors 53 and 54, also increases. The output detection voltage Vos is inputted to an inverting input terminal of the error amplifier 101 of the target waveform generation circuit 46, and the first reference voltage Er1 generated by the first reference supply 100 is inputted to a non-inverting input terminal of the error amplifier 101. The first error voltage Ve1 to be outputted is such that the first error voltage Ve1 decreases when the output detection voltage Vos becomes higher than the first reference voltage Er1, and the first error voltage Ve1 increases when the output detection voltage Vos becomes lower than the first reference voltage Er1. Accordingly, in a light load state, when the output detection voltage Vos becomes higher than the first reference voltage Er1, the first error voltage Ve1 outputted from the error amplifier 101 decreases.

The first error voltage Ve1 is inputted to the calculator 105 of the light load detection circuit 45, and compared with the second reference voltage Er2 inputted from the second reference supply 104. If the first error voltage Ve1 has become lower than or equal to the second reference voltage Er2, the calculator 105 of the light load detection circuit 45 outputs, as the light load detection signal Vll, a voltage (k2(Er2−Ve1)) proportional to the differential voltage (Er2−Ve1) obtained by subtracting the first error voltage Ve1 from the second reference voltage Er2. That is, the light load detection circuit 45 determines the load state to be a light load state if the first error voltage Ve1 has become lower than or equal to the second reference voltage Er2. In a light load state, the first error voltage Ve1 decreases in accordance with a decrease in the load 5, and as a result, the voltage value of the light load detection signal Vll increases. On the other hand, when not in a light load state, i.e., in a case where the first error voltage Ve1 is higher than the second reference voltage Er2, zero level is outputted as the voltage value of the light load detection signal Vll. Accordingly, light load detection can be performed with high precision by optimally setting the first reference voltage Er1 and the second reference voltage Er2.

The light load detection signal Vll outputted from the calculator 105 of the light load detection circuit 45 is inputted to the calculator 102 of the target waveform generation circuit 46, and compared with the input detection voltage Vis. If the input detection voltage Vis is lower than or equal to the voltage value of the light load detection signal Vll, the calculator 102 outputs zero level as the target waveform reference voltage Vx. If the input detection voltage Vis is higher than the voltage value of the light load detection signal Vll, the calculator 102 outputs, as the target waveform reference voltage Vx, a second differential voltage (Vis−Vll) obtained by subtracting the light load detection signal Vll from the input detection voltage Vis. That is, in a light load state (Vll>0), in a period in which the voltage value of the light load detection signal Vll is higher than the input detection voltage Vis, the calculator 102 generates a zero level period by outputting zero level, and in a period in which the voltage value of the light load detection signal Vll is lower than or equal to the input detection voltage Vis, the calculator 102 outputs the second differential voltage (Vis−Vll) as the target waveform reference voltage Vx. When not in a light load state, since the light load detection signal Vll=0, the second differential voltage (Vis−Vll) outputted as the target waveform reference voltage Vx is the input detection voltage Vis.

Further, the target waveform reference voltage Vx outputted from the calculator 102 of the target waveform generation circuit 46 is inputted to the multiplier 103, and the multiplier 103 generates the target waveform voltage Vr by multiplying the target waveform reference voltage Vx by the first error voltage Ve1. It should be noted that the target waveform voltage Vr outputted from the multiplier 103 may be a voltage that is proportional to the voltage obtained by multiplying the target waveform reference voltage Vx by the first error voltage Ve1. Specifically, in the present embodiment, the multiplier 103 multiplies the target waveform reference voltage Vx, the first error voltage Ve1, and a multiplier coefficient k1 together, and outputs a resultant voltage as the target waveform voltage Vr (Vr=k1·Vx·Ve1).

Based on the above, when not in a light load state (i.e., in the case of Ve1>Er2), the target waveform voltage Vr is represented as Vr=k1·Ve1·Vis, whereas in a light load state (i.e., in the case of Ve1≦Er2), if Vis>k2 (Er2−Ve1), then the target waveform voltage Vr is represented as Vr=k1·Ve1·(Vis−k2(Er2−Ve1)), and if Vis≦k2(Er2−Ve1), then the target waveform voltage Vr is represented as Vr=0.

As described above, the load state is determined to be a light load state if the voltage Ve1 (first error voltage) based on the supplied power to the load has become lower than or equal to the predetermined reference voltage Er2 (second reference voltage). In the case where the load state is determined to be a light load state, such a voltage waveform as to cause the amplitude of the generated target waveform to become zero level is generated in a period in which the voltage Vis based on the input DC voltage Vi is lower than or equal to the voltage (k2(Er2−Ve1)) proportional to the first differential voltage obtained by subtracting the voltage Ve1 based on the supplied power from the reference voltage Er2. Thus, with a simple configuration, determination can be made as to whether the load state is a light load state or not, and also, a zero level period can be set in accordance with the degree of the light load. Moreover, the target waveform voltage Vr is generated by multiplying the voltage based on the output DC voltage Vo (first error voltage Ve1) by the target waveform reference voltage Vx outputted from the target waveform generation circuit 46. As a result, the switch 41 is driven such that the output DC voltage Vo applied to the load 5 becomes a predetermined voltage value. Consequently, even in a light load state, the output DC voltage Vo applied to the load 5 can be stabilized to be a desired voltage value.

Furthermore, based on the target waveform voltage Vr and the inductor current, the drive signal generation circuit 47 generates the drive signal Vg which causes the switch 41 to perform switching. To be specific, the boost converter 4 includes, as the current detection circuit 44, a detection resistor 44a for detecting a voltage that is based on the inductor current. The drive signal generation circuit 47 includes: an inverter 106 configured to invert a voltage Vc1 (negative voltage), which is obtained by the detection resistor 44a and which is based on the inductor current, into a positive inverted voltage Vc2, and to output the inverted voltage Vc2; an error amplifier 107 configured to amplify an error between the inverted voltage Vc2 outputted from the inverter 106 and the target waveform voltage Vr outputted from the target waveform generation circuit 46; an oscillating circuit 108 configured to generate a ramp voltage (sawtooth-wave voltage) Vt which repeatedly increases and decreases at a predetermined switching frequency fs; and a comparator 109 configured to generate the drive signal Vg which causes the switch 41 to perform switching, by comparing an output voltage (second error voltage) Ve2 from the error amplifier 107 with the ramp voltage Vt. The target waveform voltage Vr is inputted to a non-inverting input terminal of the error amplifier 107, and the inverted voltage (inductor current detection voltage) Vc2 obtained from the voltage Vc1 based on the inductor current is inputted to an inverting input terminal of the error amplifier 107. The error amplifier 107 outputs the second error voltage Ve2, which is obtained by amplifying the error between the target waveform voltage Vr and the inverted voltage Vc2.

Described below is an operation of stabilizing the output DC voltage Vo, the operation being performed by the switching power supply device to which the power factor correction converter according to the present embodiment with the above-described configuration is applied. It should be noted that the switching frequency fs (several tens of kHz to several hundreds of kHz) of the switch 41 according to the present embodiment is sufficiently higher than the input AC frequency (several tens of Hz) of the power supply voltage Va, and it is assumed that a variation in the input DC voltage Vi within the switching cycle of the switch 41 is ignorable.

First, when the switch 41 is turned ON, the input DC voltage Vi is applied to the inductor 40, and a linearly increasing current flows through the following path: AC power supply 1→input filter 2→full-wave rectifier circuit 3→inductor 40→switch 41→full-wave rectifier circuit 3→input filter 2→AC power supply 1. Accordingly, energy is stored in the inductor 40.

Next, when the switch 41 is turned OFF, a differential voltage between the output DC voltage Vo and the input DC voltage Vi is applied to the inductor 40, and a linearly decreasing current flows through the following path: AC power supply 1→input filter 2→full-wave rectifier circuit 3→inductor 40→diode 42→output capacitor 43 and load 5→full-wave rectifier circuit 3→input filter 2→input AC power supply 1. Accordingly, the energy stored in the inductor 40 is released and the output capacitor 43 is charged, and also, energy is supplied to the load 5 based on the output DC voltage Vo applied to the output capacitor 43.

In the above manner, a triangular wave current (inductor current), in which linear increase and decrease are repeated in accordance with switching operation of the switch 41, flows through the inductor 40. An input alternating current supplied from the AC power supply 1 and flowing through an AC line is a result of the triangular-wave inductor current being averaged mainly by the input filter 2. If the proportion of a connected time to a switching cycle, i.e., a duty ratio δ, increases, then the inductor current increases. As a result, output power increases. In contrast, if the duty ratio δ decreases, the inductor current decreases. As a result, output power decreases. That is, the inductor current and the output power can be controlled by adjusting the duty ratio δ.

In the drive signal generation circuit 47, the drive signal Vg, which is a pulse signal controlling the switching operation of the switch 41, is generated through a comparison by the comparator 109 between the second error voltage Ve2 and the ramp voltage Vt generated by the oscillating circuit 108. The second error voltage Ve2 is generated as a result of the error amplifier 107 amplifying the error between the target waveform voltage Vr and the inductor current detection voltage Vc2. For example, if a state where the inductor current detection voltage Vc2 is higher than the target waveform (voltage) Vr continues, then the second error voltage Ve2 decreases and the duty ratio δ of the drive signal Vg decreases. This causes a decrease in the inductor current, and the output DC voltage Vo decreases, accordingly. In contrast, if a state where the inductor current detection voltage Vc2 is lower than the target waveform Vr continues, then the second error voltage Ve2 increases and the duty ratio δ of the drive signal Vg increases. This causes an increase in the inductor current, and the output DC voltage Vo increases, accordingly. Through the feedback thus described, the switching power supply device including the boost converter 4 serving as the power factor correction converter operates such that the inductor current detection voltage Vc2 follows the target waveform voltage Vr. That is, an input current, which is an average value of the inductor current, is proportional to the target waveform voltage Vr.

As described above, when not in a light load state, the target waveform voltage Vr is proportional to a value that is obtained by multiplying the first error voltage Ve1 and the input detection voltage Vis together. If the response frequency of the error amplifier 101 of the target waveform generation circuit 46 is set to be sufficiently lower than the frequency of the input current, then the first error voltage Ve1 will become a DC value that rarely varies over one cycle of the input DC voltage Vi. Accordingly, the target waveform voltage Vr is proportional to the input detection voltage Vis which has a full-wave rectification waveform, and the target waveform voltage Vr has a waveform whose wave height value increases and decreases in accordance with the first error voltage Ve1. For example, if a state where the output detection voltage Vos is higher than the first reference voltage Er1 continues, then the first error voltage Ve1 decreases and the wave height value of the target waveform voltage Vr decreases. This causes a decrease in the input alternating current, and the output detection voltage Vos decreases, accordingly. In contrast, if a state where the output detection voltage Vos is lower than the first reference voltage Er1 continues, then the first error voltage Ve1 increases and the wave height value of the target waveform voltage Vr increases. This causes an increase in the input alternating current, and the output detection voltage Vos increases, accordingly. Through the feedback thus described, the power factor correction converter adjusts the amplitude of the input alternating current such that the output DC voltage Vo is stabilized. As a result, the input alternating current has a waveform in which the absolute value of the amplitude is proportional to the amplitude value of the input DC voltage.

Next, operations performed in a light load state are described. If the electric power supplied to the load 5, i.e., the output current Io from the boost converter 4, decreases and the load state has become a light load state, then the output DC voltage Vo increases and the output detection voltage Vos increases, accordingly. This causes a decrease in the first error voltage Ve1. In the light load detection circuit 45, if the first error voltage Ve1 becomes lower than or equal to the second reference voltage Er2, the light load detection signal Vll increases. In the target waveform generation circuit 46, the target waveform reference voltage Vx and the target waveform voltage Vr become zero level when the input detection voltage Vis is in a range equal to or lower than the voltage value of the light load detection signal Vll. Accordingly, the zero level period of the target waveform voltage Vr becomes longer in accordance with a decrease in the output current Io. This makes it possible to suppress a decrease in the wave height value of the target waveform voltage Vr. As a result, the boost converter 4 operates such that the current detection voltage Vc2 follows the target waveform whose zero level period is adjusted. Although the zero level period adjustment causes slight power factor degradation, the output DC voltage Vo can be stabilized while maintaining the wave height value of the current to be high. This makes it possible to prevent the inductor current value, which is to be controlled, from becoming excessively small, and to realize stable operation in a lighter load range.

### Embodiment 2

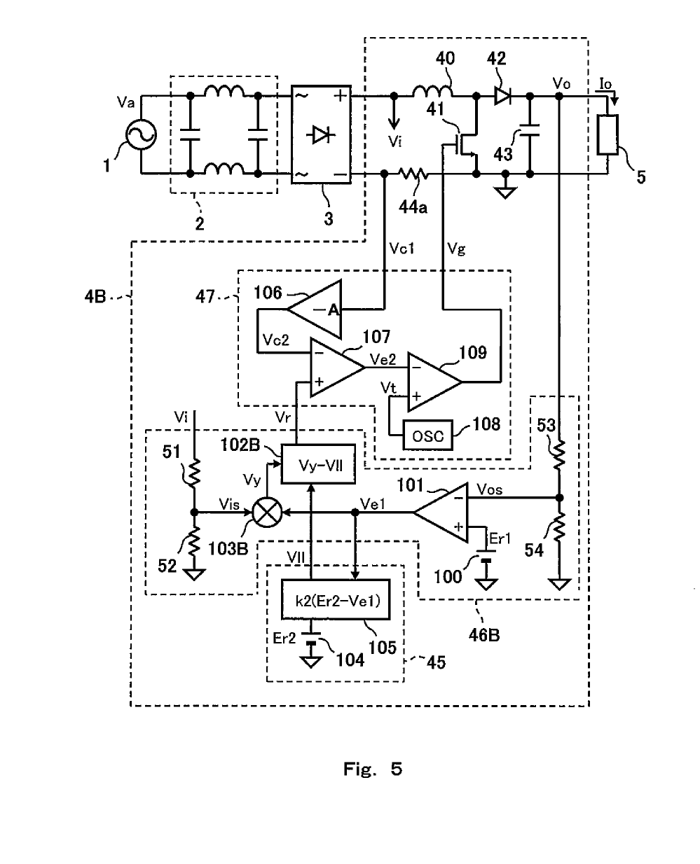

Next, a power factor correction converter according to Embodiment 2 of the present invention is described. FIG. 5 is a circuit diagram showing an example of a schematic configuration of a switching power supply device to which the power factor correction converter according to Embodiment 2 of the present invention is applied. In the present embodiment, the same components as those described in Embodiment 1 are denoted by the same reference signs as those used in Embodiment 1, and a description of such components is omitted. A power factor correction converter 4B according to the present embodiment is different from Embodiment 1 in that, as shown in FIG. 5, a target waveform generation circuit 46B includes a multiplier 103B and a calculator 102B in place of the calculator 102 and the multiplier 103 of Embodiment 1. The multiplier 103B generates a multiplied voltage Vy which is obtained by multiplying together the voltage Vis based on the input DC voltage Vi and the voltage Ve1 based on the output DC voltage Vo. If the multiplied voltage Vy is lower than or equal to the voltage value of the light load detection signal Vll, the calculator 102B outputs zero level, and if the multiplied voltage Vy is higher than the voltage value of the light load detection signal Vll, the calculator 102B generates a target waveform (target waveform voltage Vr) by subtracting the light load detection signal Vll from the multiplied voltage Vy.

According to the above configuration, the input detection voltage Vis obtained by dividing the input DC voltage Vi and the first error voltage Ve1 are inputted to the multiplier 103B. The multiplier 103B generates the multiplied voltage Vy by multiplying the input detection voltage Vis by the first error voltage Ve1. It should be noted that, in the present embodiment, the multiplied voltage Vy outputted from the multiplier 103B may be a voltage that is proportional to the voltage obtained by multiplying the input detection voltage Vis by the first error voltage Ve1. Specifically, in the present embodiment, the multiplier 103B multiplies the input detection voltage Vis, the first error voltage Ve1, and the multiplier coefficient k1 together, and outputs a resultant voltage as the multiplied voltage Vy (Vy=k1·Vis·Ve1).

In the present embodiment, the light load detection signal Vll and the multiplied voltage Vy are inputted to the calculator 102B of the target waveform generation circuit 46B, and the light load detection signal Vll and the multiplied voltage Vy are compared with each other. If the multiplied voltage Vy is lower than or equal to the voltage value of the light load detection signal Vll, the calculator 102B outputs zero level as the target waveform voltage Vr, and if the multiplied voltage Vy is higher than the voltage value of the light load detection signal Vll, the calculator 102B outputs, as the target waveform voltage Vr, a second differential voltage (Vy−Vll) obtained by subtracting the voltage value of the light load detection signal Vll from the multiplied voltage Vy.

Based on the above, when not in a light load state (i.e., in the case of Ve1>Er2), the target waveform voltage Vr is represented as Vr=k1·Ve1·Vis, whereas in a light load state (i.e., in the case of Ve1≦Er2), if Vy>Vll, then the target waveform voltage Vr is represented as Vr=k1·Ve1·k2·(Er2−Ve1), and if Vy≦Vll, then the target waveform voltage Vr is represented as Vr=0. Here, if Vy=Vll, then Vis=(k2/k1)·((Er2/Ve1)−1).

Also with the above-described configuration, in a case where the light load detection signal Vll indicates a light load state when the voltage Vis based on the input DC voltage Vi and the voltage Ve1 based on the output DC voltage Vo have previously been multiplied together, such a voltage waveform voltage Vr as to cause the amplitude of the generated target waveform to become 0 is generated in a period in which the multiplied voltage Vy is lower than or equal to the voltage (the voltage value of the light load detection signal Vll) proportional to the first differential voltage obtained by subtracting the voltage Ve1 based on the supplied power from the reference voltage Er2. Thus, with a simple configuration, a light load state can be detected; a zero level period can be set in accordance with the degree of the light load; and the output DC voltage Vo can be stabilized to be a desired voltage value.

Although specific operations performed in Embodiment 2 are the same as those described in Embodiment 1, operations performed in a light load state are described below.

If the electric power supplied to the load 5, i.e., the output current Io from the boost converter 4, decreases and the load state has become a light load state, then the output detection voltage Vos increases in accordance with an increase in the output DC voltage Vo. This causes a decrease in the first error voltage Ve1. In the light load detection circuit 45, if the first error voltage Ve1 becomes lower than or equal to the second reference voltage Er2, the light load detection signal Vll increases. In the target waveform generation circuit 46B, the target waveform voltage Vr outputted from the calculator 102B becomes zero level when the multiplied voltage Vy outputted from the multiplier 103B is in a range equal to or lower than the voltage value of the light load detection signal Vll. Accordingly, similar to Embodiment 1, the zero level period of the target waveform voltage Vr becomes longer in accordance with a decrease in the output current Io. This makes it possible to suppress a decrease in the wave height value of the target waveform voltage Vr. As a result, the boost converter 4 operates such that the current detection voltage Vc2 follows the target waveform whose zero level period is adjusted. Although the zero level period adjustment causes slight power factor degradation, the output DC voltage Vo can be stabilized while maintaining the wave height value of the current to be high. This makes it possible to prevent the inductor current value, which is to be controlled, from becoming excessively small, and to realize stable operation in a lighter load range.

### Embodiment 3

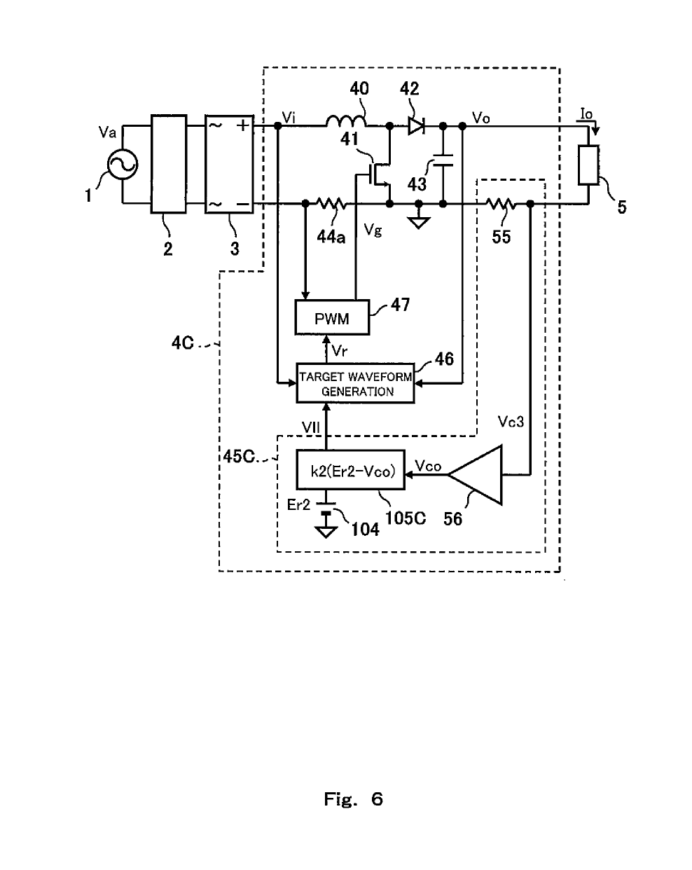

Next, a power factor correction converter according to Embodiment 3 of the present invention is described. FIG. 6 is a circuit diagram showing an example of a schematic configuration of a switching power supply device to which the power factor correction converter according to Embodiment 3 of the present invention is applied. In the present embodiment, the same components as those described in Embodiment 1 are denoted by the same reference signs as those used in Embodiment 1, and a description of such components is omitted. A power factor correction converter 4C according to the present embodiment is different from Embodiment 1 in that, as shown in FIG. 6, a light load detection circuit 45C according to the present embodiment is configured to detect, as supplied power to the load 5, the output current Io flowing through the load 5. Specifically, the light load detection circuit 45C includes: a detection resistor 55 configured to detect the output current Io as a voltage value (output detection voltage Vc3); an amplifier (amplifier circuit) 56 configured to amplify the output detection voltage Vc3 detected by the detection resistor 55, and output a resultant amplified voltage Vco; and a calculator 105C configured to calculate the light load detection signal Vll based on the amplified voltage Vco and the second reference voltage Er2.

If the amplified voltage Vco based on the output current Io has become lower than or equal to the second reference voltage Er2, the calculator 105C outputs, as the light load detection signal Vll, a voltage (k2(Er2−Vco)) proportional to a differential voltage (Er2−Vco) obtained by subtracting the amplified voltage Vco from the second reference voltage Er2. That is, the light load detection circuit 45C determines the load state to be a light load state if the amplified voltage Vco based on the output current Io has become lower than or equal to the second reference voltage Er2.

In a light load state, the output current Io decreases in accordance with a decrease in the load 5, and as a result, the output detection voltage Vc3 decreases. Accordingly, the light load detection signal Vll increases since the amplified voltage Vco also decreases in accordance with the decrease in the load 5. On the other hand, when not in a light load state, i.e., in a case where the amplified voltage Vco is higher than the second reference voltage Er2, zero level is outputted as the light load detection signal Vll. Accordingly, light load detection can be performed with high precision by optimally setting the second reference voltage Er2.

Although the embodiments of the present invention have been described above, the present invention is not limited to the above embodiments, and various improvements, alterations, and modifications can be made to the above embodiments without departing from the spirit of the present invention. For example, components in the plurality of above-described embodiments and variations may be combined in any manner.

From the foregoing description, numerous modifications and other embodiments of the present invention are obvious to one skilled in the art. Therefore, the foregoing description should be interpreted only as an example and is provided for the purpose of teaching the best mode for carrying out the present invention to one skilled in the art. The structural and/or functional details may be substantially altered without departing from the spirit of the present invention.

### INDUSTRIAL APPLICABILITY

The switching power supply device according to the present invention is capable of adjusting an inductor current with high precision even in a light load state, and is useful for stabilizing an output to a load at a lower inductor current.

### REFERENCE SIGNS LIST

1 AC power supply
2 input filter
3 full-wave rectifier circuit (rectifier)
4, 4B, 4C boost converter (power factor correction converter)
5 load
40 inductor
41 switch
42 diode (rectifier circuit element)
43 output capacitor (power storage circuit element)
44 current detection circuit
44a, 55 detection resistor
45, 45C light load detection circuit
46, 46B target waveform generation circuit
47 drive signal generation circuit
51, 52, 53, 54 resistor
100 first reference supply
101 error amplifier
102, 102B calculator
103, 103B multiplier
104 second reference supply
105, 105C calculator
106 inverter
107 error amplifier
108 oscillating circuit
109 comparator

What is claimed is:

1. A power factor correction converter comprising:
a rectifier configured to rectify an AC voltage inputted from an AC power supply into an input DC voltage;
an inductor, one end of which is connected to a positive output terminal of the rectifier and to which the input DC voltage is applied;
a power storage circuit element connected to another end of the inductor via a rectifier circuit element and configured to generate, by storing electric power, an output DC voltage to be outputted to a load;
a switch, one main terminal of which is connected to the other end of the inductor and another main terminal of which is connected to a negative output terminal of the rectifier, the switch being configured to perform switching operations of connecting between the inductor and the negative output terminal to store energy in the inductor and disconnecting between the inductor and the negative output terminal to charge the power storage circuit element;
a light load detection circuit configured to generate, if supplied power to the load is less than or equal to a predetermined value, a light load detection signal whose level corresponds to the supplied power;
a target waveform generation circuit configured to generate, based on the input DC voltage, a target waveform of an inductor current flowing through the inductor; and
a drive signal generation circuit configured to generate a drive signal driving the switch such that the inductor current follows the target waveform, wherein
the target waveform generation circuit is configured to generate, if the light load detection signal indicates a light load, the target waveform that includes a period in which an amplitude of the target waveform is zero level (hereinafter, a zero level period), the zero level period being adjusted in accordance with the level of the light load detection signal.

2. The power factor correction converter according to claim 1, wherein the target waveform generation circuit is configured to generate, based on the output DC voltage, the target waveform that causes the output DC voltage to have a predetermined voltage value.

3. The power factor correction converter according to claim 1, wherein
the light load detection circuit is configured such that, if a voltage based on the supplied power has become lower than or equal to a predetermined reference voltage, the light load detection circuit outputs, as the light load detection signal, a voltage proportional to a first differential voltage obtained by subtracting the voltage based on the supplied power from the reference voltage, and
the target waveform generation circuit is configured such that, if a voltage based on the input DC voltage is lower than or equal to a voltage value of the light load detection signal, the target waveform generation circuit generates the target waveform such that the amplitude of the target waveform becomes zero level.

4. The power factor correction converter according to claim 1, wherein the light load detection circuit is configured to detect the output DC voltage as the supplied power.

5. The power factor correction converter according to claim 1, wherein the light load detection circuit is configured to detect, as the supplied power, an output current flowing through the load.

6. The power factor correction converter according to claim 2, wherein
the light load detection circuit is configured to:
compare a voltage based on the output DC voltage that is inputted to the target waveform generation circuit with a predetermined reference voltage; and
if the voltage based on the output DC voltage has become lower than or equal to the reference voltage, output, as the light load detection signal, a voltage proportional to differential power obtained by subtracting the voltage based on the output DC voltage from the reference voltage, and
the target waveform generation circuit includes:
a calculator configured such that, if a voltage based on the input DC voltage is lower than or equal to a voltage value of the light load detection signal, the calculator outputs zero level, and if the voltage based on the input DC voltage is higher than the voltage value of the light load detection signal, the calculator outputs a second differential voltage obtained by subtracting the voltage value of the light load detection signal from the voltage based on the input DC voltage; and
a multiplier configured to generate the target waveform by multiplying a voltage outputted from the calculator by the voltage based on the output DC voltage.

7. The power factor correction converter according to claim 2, wherein
the light load detection circuit is configured to:
compare a voltage based on the output DC voltage that is inputted to the target waveform generation circuit with a predetermined reference voltage; and
if the voltage based on the output DC voltage has become lower than or equal to the reference voltage, output, as the light load detection signal, a voltage proportional to differential power obtained by subtracting the voltage based on the output DC voltage from the reference voltage, and
the target waveform generation circuit includes:
a multiplier configured to generate a multiplied voltage by multiplying together a voltage based on the input DC voltage and the voltage based on the output DC voltage; and
a calculator configured such that, if the multiplied voltage is lower than or equal to a voltage value of the light load detection signal, the calculator outputs zero level, and if the multiplied voltage is higher than the voltage value of the light load detection signal, the calculator generates the target waveform by subtracting the voltage value of the light load detection signal from the multiplied voltage.
